(19) United States
(12) Patent Application Publication
(10) Pub. No.: US 2008/0121585 A1
(43) Pub. Date: May 29, 2008

(54) WATER TREATMENT USING DE-SUPERSATURATION

(76) Inventor: James D. Mavis, Kirkland, WA (US)

Correspondence Address: PERKINS COIE LLP, POST OFFICE BOX 1208, SEATTLE, WA, 98111-1208, US

(21) Appl. No.: 11/945,012

(22) Filed: Nov. 26, 2007

Related U.S. Application Data
(60) Provisional application No. 60/867,298, filed on Nov. 27, 2006.

(51) Int. Cl. C02F 9/02

(52) U.S. Cl. 210/652; 204/542; 210/195.2; 210/195.3; 210/255; 210/714

(57) ABSTRACT

A method for treating water includes removing a supersaturated sparingly soluble salt via a self-sustaining de-supersaturation process in which the supersaturated water is contacted with a nucleation material that is reused in the process. Supersaturated reject water from reverse osmosis systems may be de-supersaturated, reducing scale formation on downstream water treatment systems and pipelines. The method may be used for treatment of sulfate-contaminated groundwater, and groundwater contaminated via mining and processing of sulfide ores, and in other applications.

### PRIORITY CLAIM

This application claims priority to U.S. Provisional patent application No. 60/867,298, filed Nov. 27, 2006, and incorporated herein by reference.

### BACKGROUND

Mineral scaling substances can deposit from aqueous solution onto process equipment and pipelines, increasing costs for process operation, maintenance, cleaning and lost production. Typical mineral scaling substances include calcium sulfate (gypsum), barium sulfate, strontium sulfate, calcium carbonate, barium carbonate, strontium carbonate, calcium fluoride, magnesium hydroxide and silica. Other types of mineral scale can also form, although less frequently, including magnesium silicate, magnesium ammonium phosphate and calcium phosphate. Methods to prevent scale formation in a wide range of commercial processing facilities such as membrane desalination plants, ore processing facilities, cooling towers and wastewater streams from these and other commercial facilities could beneficially be used to conserve water and reduce the volume of wastewater requiring disposal.

Reverse osmosis is a well known technique for water treatment. It is widely used in water purification, remediation and desalination. Generally, in reverse osmosis (RO), water under pressure passes through a semi-permeable membrane. The membrane is formed as a hollow fiber, a hollow tube, a flat sheet or a spiral wound configuration. The membrane allows passage of purified water but acts as a virtually impenetrable barrier to the solids dissolved in the water. The water that passes through the membrane is substantially pure and may be removed from the RO system and used with little or no further treatment. Since the dissolved solids cannot pass through the membrane, they remain in the water on the upstream side of the membrane (referred to as the reject water). As a result, the concentration of dissolved solids in the reject water increases, often to the level at which sparing-soluble salts become supersaturated. Depending on the specific RO system design, the reject water may move to a second or subsequent membrane, where further purified water is produced, or it may be moved out of the system for release or further processing or disposal.

Under typical operating conditions, some types of dissolved solids, typically sparingly-soluble salts, can precipitate out on the membrane and other surfaces as solid deposits or scale. The salts or dissolved solids that ordinarily cause scaling include calcium carbonate or calcium sulfate (gypsum). Scaling may also be caused by barium sulfate, strontium sulfate, calcium fluoride or silica, as well as other sparingly soluble compounds.

Scaling tends to cause fouling or clogging of the membrane. As a result, purified water output from the RO system may be reduced and its quality may deteriorate. As scale clogged membranes are expensive and time consuming to replace, RO systems are typically operated under conditions that avoid scaling, even though this tends to reduce their efficiency. Specifically, due to the onset of scale formation, there are upper limits on the concentrations of dissolved solids in water that RO systems can effectively handle. Correspondingly, scale formation limits the maximum concentration of salts or solids in the reject water stream from the RO system and reduces the amount of purified water that can be recovered for beneficial use.

Generally, the cost of disposing of reject or waste water is much more dependent on the volume of water to be disposed of, and much less dependent on the concentration of dissolved solids in the reject water. Accordingly, in many water treatment systems, including mine de-watering, inland desalination plants, or cooling tower blowdown reclamation systems, it is advantageous to minimize the volume (and maximize the solids concentration) of the final waste water produced by the system. This makes post treatment of the final waste water (in evaporation ponds, mechanical evaporators, mechanical crystallizers, etc.) more cost efficient, as the volume of the final waste water that needs post treatment is reduced. At the same time, however, the membranes in these systems are particularly prone to scaling, due to the high concentration of dissolved solids in the waste water. In current systems, the maximum permissible concentration of dissolved solids in the waste water tends to be limited to avoid scale formation. Electrodialysis reversal (EDR) water treatment systems, which also use semi-permeable membranes, generally have similar scaling problems.

Chemical scale inhibitors are commonly used in RO systems to reduce scale formation on the membranes. Scale inhibitors delay formation of scale, but in general do not permanently prevent precipitation of scale-forming substances. By using chemical scale inhibitors, the concentration of dissolved solids may often be increased to two or three times or more of the normal saturation level, without scaling, reducing the volume of wastewater volume accordingly. This is generally effective for reducing scaling on upstream membranes, which are in contact only with water having relatively lower concentrations of dissolved scale-forming solids. Downstream membranes, however, are in contact with water having much higher dissolved concentrations. Even with use of chemical scale inhibitors, scale may form on these membranes, thus degrading the performance of water treatment system. In addition, when operating with supersaturated solutions, an initial precipitation of scale generally will cause more supersaturated gypsum or other sparingly-soluble salt to quickly precipitate out as scale, potentially damaging or degrading the membranes.

Use of RO or EDR systems for desalination converts brackish or saline water to potable water, or low salinity water, that can be used for beneficial purposes or can be discharged into the environment without adverse effects. A smaller volume of more saline waste water is also produced, and is more difficult to dispose of. Currently, this more saline waste water is handled by sending it an evaporation pond, optionally after concentrating it even further in a mechanical evaporator. In some desalination systems, the saline waste water is concentrated in a mechanical evaporator, and then converted into water or water vapor and dry salts in a mechanical crystallizer, scraped film evaporator or spray dryer. Operation of these types of apparatus is relatively expensive and complicated. Accordingly, reducing the size or eliminating the need for these expensive types of apparatus would be advantageous. Concentrating the salts beyond the levels currently economically achievable using RO or EDR would accordingly allow for more efficient and less costly water treatment and disposal of wastewater.

Mining and processing of sulfide ores usually results in generation of sulfate- and sulfuric acid-containing streams. Lime (calcium oxide or calcium hydroxide) is widely used in ore processing operations to adjust the acid-alkali balance (pH) to optimize recovery of mineral values. Process streams and waste streams containing high sulfate concentrations may be mixed with lime-treated streams that contain elevated calcium concentrations. When sulfate- and calcium-containing streams are blended, the combined stream may become supersaturated with gypsum, causing pipelines and process equipment to become scaled with gypsum. The process stream may remain supersaturated with for considerable time before precipitation is complete, causing extensive scale formation on piping and process equipment. Consequently, a means of eliminating supersaturation at the point at which the two non-scale-forming streams joins to form a single gypsum-supersaturated, scale-forming stream would reduce the cost to operate, clean and maintain the equipment and pipelines.

Mining and ore processing streams containing elevated sulfate concentrations and elevated calcium concentrations streams may also contain high concentrations of suspended solids that may serve as a nucleation medium for de-supersaturation of gypsum or other sparing-soluble, scale-forming minerals. Solids-containing streams may include the underflow from a gravity settler such as a tailing thickener or the effluent from a hydrocyclone, which may be mixed with the sulfate-rich stream in a de-supersaturation reactor, where gypsum or other scale-forming substances would be precipitated. The use of a solids-containing stream may obviate the need to recovery precipitated solids for recycle back to the de-supersaturation reactor, and be self-sustaining by virtue of the suspended solid material in the solids-rich stream.

Accordingly, improved water treatment systems and methods are needed.

### SUMMARY

A method for treating water includes performing a reverse osmosis or an electrodialysis step in a first reverse osmosis or EDR system to separate intake water into purified clean water and reject water, with the reject water supersaturated with a dissolved solid. The reject water is moved into a reactor where it is de-supersaturated, by causing dissolved solids to precipitate out onto a suspension, packed bed or fluidized bed of the scale-forming mineral. The de-supersaturation process may be self-sustaining by recycling some of the precipitated solids back to the de-supersaturation reactor to act as nucleation substrate onto which more scale-forming material precipitates. The de-supersaturated water is moved to a second reverse osmosis or EDR system and a second reverse osmosis or EDR step is performed on the de-supersaturated water. Scale inhibitors may be added to the de-supersaturated water, before performing the second reverse osmosis or electro-dialysis step.

The de-supersaturation may be carried out in a stirred tank reactor, a fluidized bed reactor, a packed bed reactor, or other equipment. A clarifier may be used to separate the de-supersaturated water into a substantially solids-free first flow provided to the second reverse osmosis system, and a second flow that contains precipitated solids which is returned back to the de-supersaturation reactor. De-supersaturation is typically achieved by contacting the supersaturated water with solid reactor particles which causes dissolved solids in the water to precipitate out. The solid reactor particles and the dissolved solids are generally, but not necessarily, the same material, for example, gypsum. The systems and methods described may also be used with electrodialysis and electrodialysis reversal systems. The systems and methods described may also be used to reduce scale formation in pipelines, heat exchangers or other process equipment. The invention resides as well in sub-combinations of systems and methods described.

### BRIEF DESCRIPTION OF THE DRAWINGS

FIG. 1 is a schematic diagram of a first system.

FIG. 2 is a schematic diagram of a second system.

FIG. 3 is a schematic diagram of a third system.

FIG. 4 is a schematic diagram of a system using electrodialysis.

FIG. 5 is a schematic diagram of a fourth system.

FIG. 6 is a schematic diagram of a system for ore processing.

### DETAILED DESCRIPTION OF THE DRAWINGS

Reject water or other solution from a membrane purification system, and having one or more supersaturated dissolved solids, is passed into a reactor, such as a stirred tank reactor or other solids contact reactor, containing a de-supersaturating agent. The de-supersaturating agent may be a powder or particles of the same compound that is supersaturated in the water. For example, gypsum powder may be used as a de-supersaturating agent with water supersaturated with dissolved gypsum, although other materials may be used to remove gypsum and other types of supersaturated substances. The gypsum powder relieves the supersaturation by causing the dissolved gypsum to precipitate out as solid particles in the reactor. The concentrated reject water and gypsum solids flow, e.g., by gravity, to a clarifier, where gypsum solids settle out. These solids may be pumped from the underflow back to the reactor to make the de-supersaturation process self-sustaining without need to add treatment chemicals. Alternatively, a hydrocyclone, fluidized bed or other type of device may be used to recover solids that may be returned to the de-supersaturation reactor to sustain the de-supersaturation process.

A small amount of the gypsum solids may be blown down to waste, to avoid accumulation of excess gypsum in the reactor. Water flows out of the clarifier, typically via overflow and may then optionally be filtered, and then fed into a second or subsequent reverse osmosis system. This further reduces the volume of, and further concentrates, the reject or waste water. This process may be repeated as necessary until it is no longer feasible due to high osmotic pressures or other factors. A packed bed or a fluidized bed of gypsum may alternatively be used instead of a tank reactor. Similarly, a hydrocyclone or other solids separation device may be used in place of a gravity settler. Process streams that already contain suspended solids before they become supersaturated, may not require solids recovery or recycle, if the solids concentration is sufficient to sustain the de-supersaturation process without need for supplemental chemicals.

The systems and methods of the invention may allow for smaller volumes of concentrated waste water that require disposal, e.g., for inland RO and EDR desalination plants. More potable or near potable water (low total dissolved solids) may also be recovered from a concentrated waste water stream. The size and cost of downstream thermal desalination systems or evaporation ponds may also be reduced. One or more of these advantages may be achieved, depending on the specific ways the invention is used.

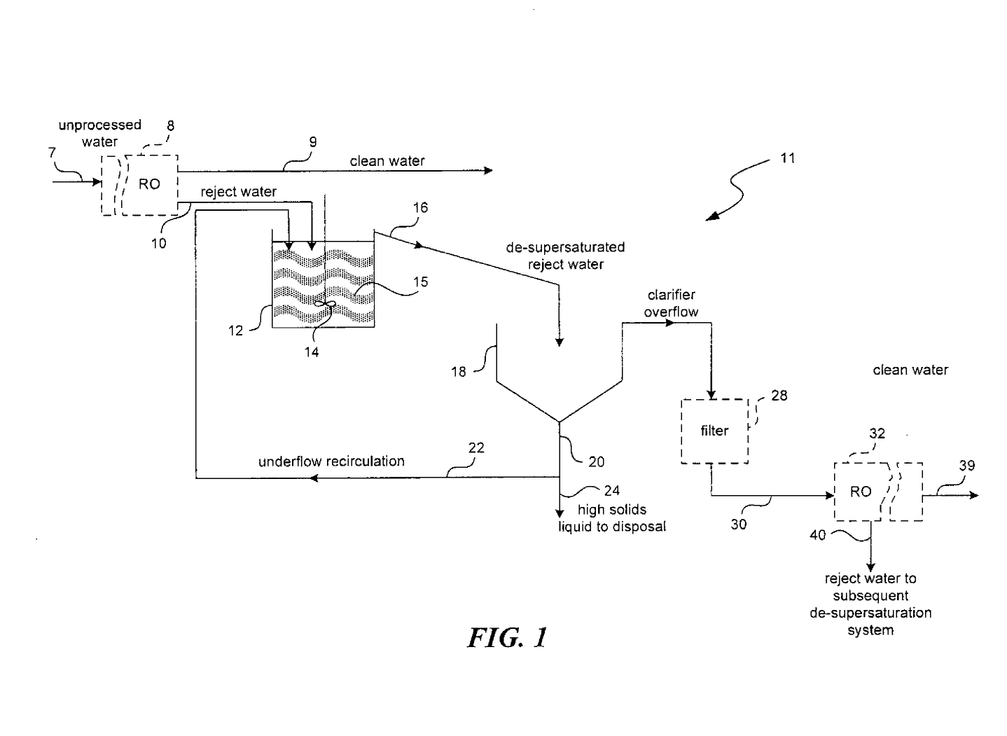

Turning now to FIG. 1 unprocessed water 7, such as sulfate-rich water from a contaminated groundwater plume, moves into an initial or first RO system 8. The system 8 processes the intake water 7 creating an outflow of clean water 9 and an outflow of reject water 10 supersaturated with one or more soluble solids. For purpose of explanation, the soluble solids, which may be various salts or other compounds, are referred to here simply as gypsum. The concentration of gypsum in the reject water is typically at least two times, and up to three and one half times, or higher, of the saturation concentration. The gypsum remains supersaturated due to scale inhibitors added to the intake water 7.

In the system in FIG. 1, the clean water 9 flows out of the system and, depending on the specific set up, may be used as potable water in a municipal drinking water supply, used for irrigation, used for industrial cooling or other municipal or industrial applications, or otherwise returned to the environment with or without any further processing.

The reject water 10 flows to a de-supersaturation system 11. The de-supersaturation system 11 generally includes a reactor 12 and a clarifier 18. FIG. 1 shows a stirred tank reactor 12 having a stirring element 14. Powdered gypsum is initially provided in the reactor 12 when the process starts operating, before the process becomes self-sustaining by virtue of the recycling of precipitated gypsum to the reactor. The presence of the gypsum particles in the reactor causes the supersaturated dissolved gypsum in the reject water 10 to precipitate, as solid gypsum particles. The now de-supersaturated reject water 10, along with a slurry of gypsum particles, overflows from reactor 12, through connection line 16 to a clarifier 18.

In the clarifier 18, overflow is collected and moved through an optional filter 28 and is then provided as intake water 30 at a second RO system 32. The filter 28, if used, may be a sand filter or a micro filter, for removing particles. A mechanical rake or plow at the bottom of the clarifier may be used to move deposited solids to the center, where they can then flow out with the underflow 20. Underflow 20 is drawn out of the bottom of the clarifier. A small amount of solids 24 are blown down or removed, to compensate for the gypsum accumulated by the de-supersaturation of the water in the reactor. The removed solids 24 are typically moved to a sludge drying bed, a plate-and-frame filter press, a centrifuge or another type of dewatering device or impoundment for reuse or disposal. The remaining underflow 22 which contains most of the solids coming out of the clarifier, is pumped back to the reactor to make the de-supersaturation process self-sustaining.

The volume of the intake water 30 for the subsequent desalination stage is a fraction of the unprocessed water 7, since a large component of the unprocessed water 7 is removed as clean water 9 in the initial RO system 8. The intake water 30 is pumped into a second RO system 32. Additional scale inhibitor is added to the intake water 30 to prevent scale formation in the second RO system 32. The intake water 30 is processed in the second RO system 32 into a second stream of clean water 39 and a second stream of reject water 40. The reject water 40 is concentrated with gypsum to supersaturation, again to the limit permitted by the scale inhibitor. The reject water 40 can then be processed in a second de-supersaturation system, in the same way as described above relative to the de-supersaturation system 11, as shown in FIG. 1. The sequence may then be repeated again, for three, four or more times.

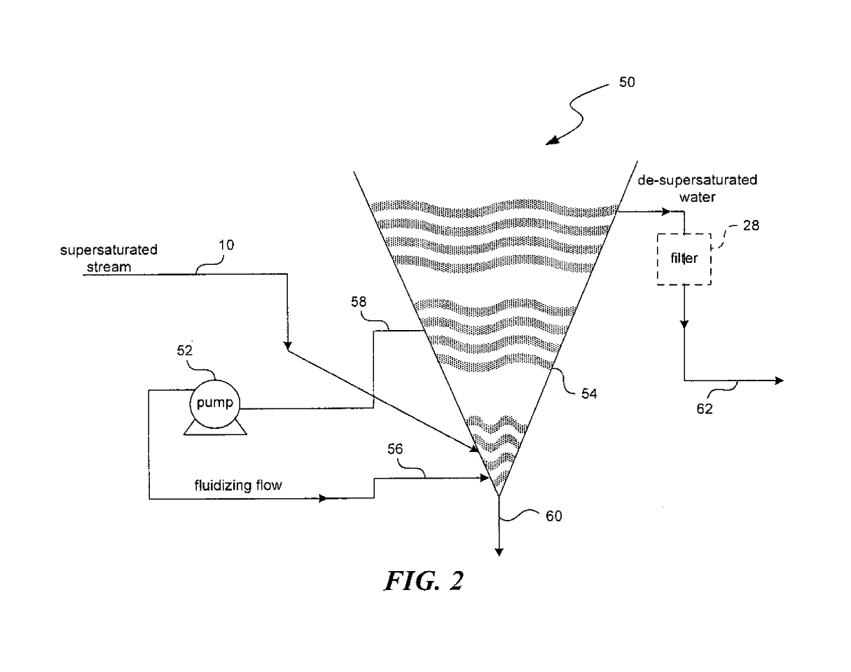

FIG. 2 shows a system similar to FIG. 1 but with the stirred reactor 18 replaced with a fluidized bed reactor system 50. As shown in FIG. 2, in the system 50, reject water 10 flows from a first RO system into the bottom of a fluidized bed reactor 54. Water 58 is pumped from fluid bed reactor 54 with a fluidizing pump 52, from the fluid bed reactor through a pipe 56 to provide upward flow through the fluidized bed. The reject water 10 is supersaturated with a dissolved solid, such as gypsum. The reject water 10 is de-supersaturated in the reactor 54. De-supersaturated water flows from the reactor 54, optionally through a filter 28, and is supplied as intake water 62 to a second RO system.

Gypsum particles grow larger as supersaturated gypsum in incoming water 10 precipitates onto suspended gypsum solids. Gypsum particles eventually become too large to remain fluidized and drop from the bottom of the reactor through a waste solids pipe 60, and are placed in a suitable repository for disposal. Some of the large gypsum particles may be undergo size reduction and be returned to the fluidized bed reactor to sustain the de-supersaturation process.

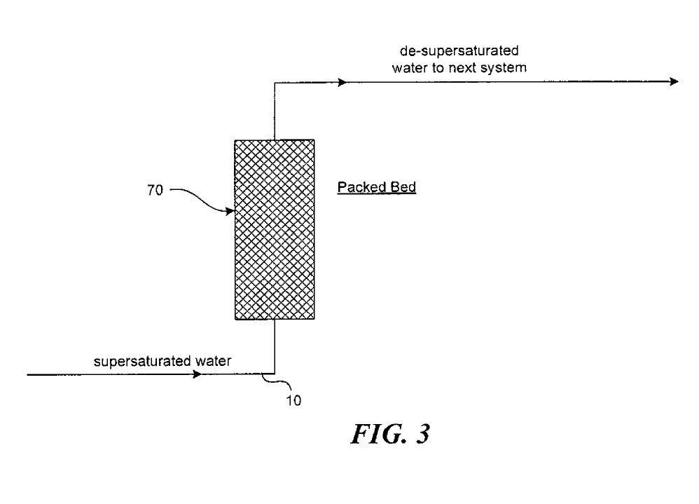

Referring to FIG. 3, a packed bed reactor 70 may also be used. In the packed bed reactor 70, the supersaturated reject water 10 is passed through a packed bed of gypsum (or other material such as barium sulfate that will cause de-supersaturation of the dissolved solid of interest). The reject water 10 is de-supersaturated in the packed bed reactor 70. Effluent from the packed bed reactor 70 is then fed to a second RO system, along with a new dose of scale inhibitor. The waste stream is then again concentrated to the limit imposed by the scale inhibitor. Other engineered surface effect reactors may also be used. In FIG. 3, the packed bed reactor 70 may be pressure tight. In this way, the reject water 10 may remain under pressure throughout the entire system. This avoids the need to repressurize the reject water as it moves from the packed bed de-supersaturation system into a second or subsequent RO system. Alternatively, the de-supersaturated water may be conveyed to another destination through a pipeline without scale forming on its interior surfaces.

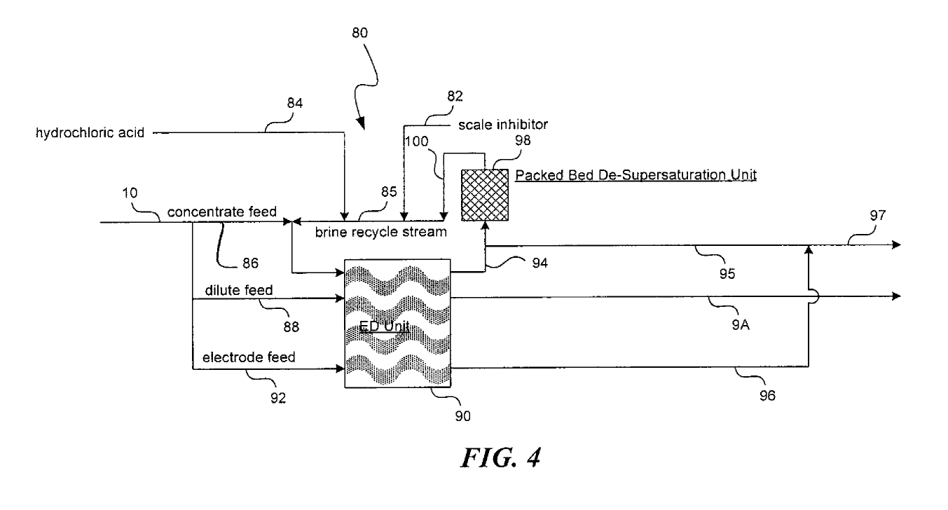

FIG. 4 is a schematic illustration of an electrodialysis system 80 with de-supersaturation. The principles illustrated here can of course also be used with electrodialysis reversal systems as well. In the system 80, the ED unit 90 has three compartments or sections. The major fraction of incoming water 10 (typically greater than 80%) is supplied as dilute feed water 88 into a dilute feed section of the ED unit 90. The dissolved solids in this dilute feed water 88 are removed via electrodialysis, resulting in an outflow 9A of clean water requiring little or no further treatment. A small fraction of incoming water 10 is introduced as concentrate feed water 86 into a concentrate recycle loop 85. A scale inhibitor 82 is added to water in the recycle loop 85. The scale inhibitor may vary with the specific application. The specific application shown in FIG. 4 is for barium sulfate, although the concepts shown in FIG. 4 may apply to other dissolved solids as well. Hydrochloric acid 84 may also be added to reduce or prevent calcium carbonate scaling.

The concentrate feed water 86 moves into a concentrate feed section of the ED unit 90. In the ED unit 90, the dissolved solids removed from the dilute feed water 88 are added to the concentrate feed water 86, to the extent that it becomes supersaturated. The supersaturated water 94 moves into a packed bed reactor 98. The packed bed reactor 98 contains solid particles which de-supersaturate the water 94. In the example shown in FIG. 4, these may be coarse barium sulfate particles. The de-supersaturated water 100 is recycled with the concentrate feed water 86 in the concentrate recycle loop 85. The concentrate recycling loop 85 accordingly moves the dissolved solids removed from the dilute feed water in the ED unit 90, from the ED unit 90 to the packed bed 98. When the packed bed 98 becomes excessively loaded with precipitated solids, it can be replaced, back-flushed, or otherwise restored. Some of the supersaturated water 94 may be removed from the concentrate recycle loop 85 via a blow down line 95 leading to a waste water outlet 97.

A small fraction of the incoming water 10 is supplied to an electrode section of the ED unit 90 as electrode feed water 92. This water is used to make electrical connections between the electrodes and the membranes in the ED unit. The electrode feed water removed from the ED unit runs to the waste water outlet 97. The waste water may then be sent for further processing. Of course, other de-supersaturation systems previously described may be used instead of a packed bed 98 used in the example illustrated in FIG. 4.

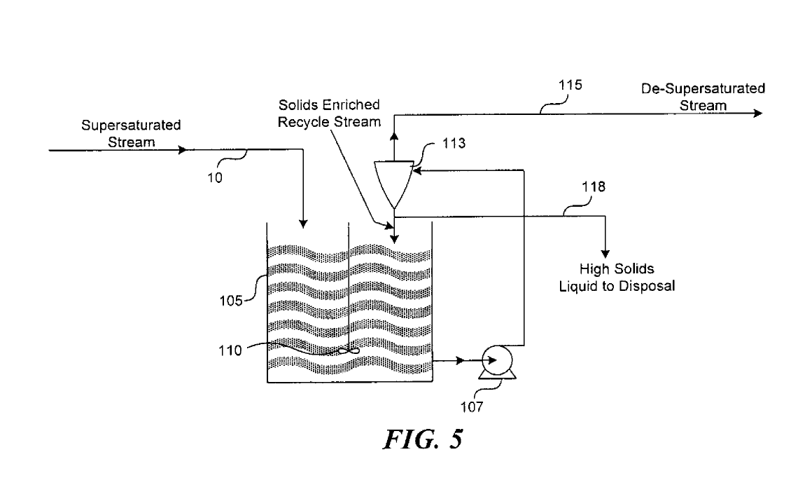

In the system in FIG. 5, water 10 that is supersaturated in a sparing soluble salt, referred to in this example as gypsum, flows into the de-supersaturation reactor 105. The de-supersaturation reactor 105 is agitated with a mixer 110 to maintain intimate contact between incoming water 10 and the contents of the reactor. The de-supersaturation reactor 105 contains a suspension of gypsum solids, which promote de-supersaturation of gypsum in the incoming water. De-supersaturated water and solids are pumped out of the reactor 105 by pump 107 and enter a hydrocyclone 113, where solids are separated from the water in the overhead discharge stream 115. The solids-enriched hydrocyclone underflow 118 is returned to the de-supersaturation reactor 10 to sustain the de-supersaturation reaction. The discharge stream 115 contains excess solids material and serves as a solids purge stream for the de-supersaturation process.

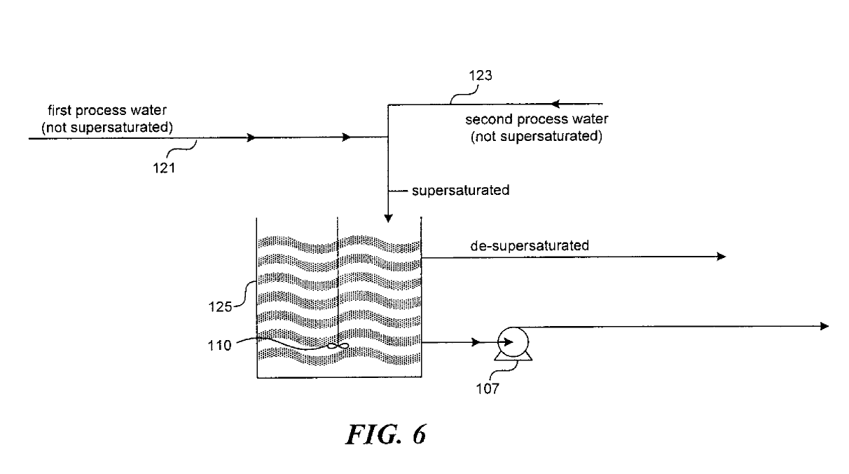

FIG. 6 shows an incoming process stream 121 that contains, for example, an elevated sulfate concentration but is not supersaturated in any sparingly soluble salt. A second process stream 123, also not supersaturated with any sparingly soluble salt but that contains a high concentration of suspended solids and has, for example, an elevated calcium concentration mixes with the first incoming stream 121 in the de-supersaturation reactor 125. When the two individual streams combine in the de-supersaturation reactor, they may exceed the gypsum saturation threshold, causing gypsum to precipitate onto the suspended solids present in the second incoming process stream 123. Thus, the suspended solids in the second incoming process stream 123 comprise a sufficient material for gypsum nucleation, and the de-supersaturation process is initiated and sustained without the need to recycle precipitated solids back to the de-supersaturation reactor, as in the previous examples. It is also possible to mix more than two non-saturated process streams in a de-supersaturation reactor, and to allow the combined streams to undergo de-supersaturation, provided precipitated solids are recovered and returned to the de-supersaturation reactor without use of purchased chemicals, as previously described.

### EXAMPLE I

In this example, a process stream that is comprised of a blend of sulfate-contaminated groundwater from a mining operation and reverse osmosis reject, is supersaturated with calcium sulfate (gypsum), and deposits gypsum scale in the pipeline through which it flows. Water from this process stream was treated by adding powdered gypsum to cause de-supersaturation of the gypsum-supersaturated water. In one test, the concentration of powdered gypsum was adjusted to two percent by weight in the supersaturated process water. The concentrations of dissolved calcium and sulfate decreased to equilibrium concentrations within one hour, as illustrated in the following table:

Initial Gypsum Concentration 2 Percent by Weight:

| | DISSOLVED | DISSOLVED |
|---|---|---|
| ELAPSED TIME | CALCIUM | SULFATE |
| 0 minutes (start of test) | 709 mg/L | 28,900 mg/L |
| 1 minute | 525 mg/L | 26,800 mg/L |
| 2 minutes | 340 mg/L | 28,000 mg/L |
| 5 minutes | 462 mg/L | 27,200 mg/L |
| 10 minutes | 473 mg/L | 27,700 mg/L |
| 20 minutes | 461 mg/L | 28,800 mg/L |
| 40 minutes | 432 mg/L | 27,200 mg/L |
| 60 minutes | 434 mg/L | Not Available |

The decreases of calcium and sulfate concentrations over the 60-minute test period relieved the supersaturated condition so the water no longer had a tendency to form scale. A similar test was performed with water from the same process stream, but with gypsum powder added to a five percent concentration to promote de-supersaturation, and the dissolved calcium and sulfate concentrations were monitored for one hour. The dissolved calcium and sulfate concentrations are reported in the following table:

Initial Gypsum Solid Concentration 5 Percent by Weight:

| | DISSOLVED | DISSOLVED |
|---|---|---|
| ELAPSED TIME | CALCIUM | SULFATE |
| 0 minutes (start of test) | 693 mg/L | 28,700 mg/L |
| 1 minute | 491 mg/L | 27,900 mg/L |
| 2 minutes | 453 mg/L | 26,200 mg/L |
| 5 minutes | 455 mg/L | 29,800 mg/L |
| 10 minutes | 454 mg/L | 28,000 mg/L |
| 20 minutes | 438 mg/L | 26,600 mg/L |
| 40 minutes | 424 mg/L | 27,300 mg/L |
| 60 minutes | 439 mg/L | 26,600 mg/L |

Water that is supersaturated with gypsum in the previous examples is relieved of supersaturation by contact with two percent powdered gypsum by weight. The de-supersaturated water will no longer form mineral scale on the pipeline or downstream process equipment.

### EXAMPLE II

This example illustrates the application of the de-supersaturation process to reverse osmosis concentrate from treatment of sulfate-contaminated groundwater from a mining operation, in a continuous flow pilot test. The major constituents in the untreated reverse osmosis concentrate stream are listed in the following table:

| | CONCEN- | | CONCEN- |
|---|---|---|---|
| COMPONENT | TRATION | COMPONENT | TRATION |
| Calcium mg/L | 1,442-1,593 | Sulfate mg/L | 5,244-5,446 |
| Magnesium mg/L | 544 | Alkalinity mg/L as | 625 |
| Sodium mg/L | 71.6 | CaCO₃ | |
| Potassium mg/L | 1.5 | TDS mg/L | 8,040 |
| Chloride mg/L | 908 | Conductivity | 5,550 |
| | | μS/cm | |
| | | pH | 7.6 |

The reverse osmosis concentrate in the preceding table is supersaturated with gypsum, and was de-supersaturated in a continuous-flow de-supersaturation pilot plant during a 19-day test period. The de-supersaturation pilot plant consisted of an agitated, continuous-flow back-mix reactor, in which gypsum was allowed to precipitate onto a suspension of gypsum solids; and a gravity thickener in which the gypsum solids were separated from clear, de-supersaturated liquid in the thickener overflow stream, and the solids were removed as a slurry in the thickener underflow stream. Most of the solids from the thickener underflow stream were returned to the agitated continuous-flow back-mix reactor to sustain the de-supersaturation reaction, and a small quantity of the thickener underflow solids was discarded as a waste stream.

The extent to which supersaturation of reverse osmosis concentrate was relieved in the agitated continuous-flow back-mix reactor at a hydraulic residence time of 10.8 to 14.4 minutes varied with the concentration of suspended solids present in the reactor, as shown in the following table. The test duration was 14 days.

| | CALCIUM | | SULFATE | |
|---|---|---|---|---|
| SOLIDS % | INITIAL | % REMOVED | INITIAL | % REMOVED |
| 1.7 | 1,521 | 19.4 | 5,364 | 12.3 |
| 11.3 | 1,494 | 45.4 | 5,349 | 32.5 |
| 11.5 | 1,531 | 44.5 | 5,323 | 28.6 |
| 12.7 | 1,516 | 36.8 | 5,416 | 26.8 |
| 17.0 | 1,506 | 54.6 | 5,339 | 34.2 |
| 17.2 | 1,495 | 55.3 | 5,446 | 37.4 |
| 18.0 | 1,486 | 49.3 | 5,246 | 31.0 |
| 19.3 | 1,509 | 46.9 | 5,288 | 30.5 |
| 20.2 | 1,554 | 50.8 | 5,276 | 33.8 |
| 20.3 | 1,593 | 52.0 | 5,323 | 33.9 |
| 20.8 | 1,509 | 50.0 | 5,276 | 33.9 |
| 20.9 | 1,509 | 48.6 | 5,269 | 34.4 |
| 21.4 | 1,549 | 50.2 | 5,369 | 36.4 |
| 21.9 | 1,526 | 41.6 | 5,311 | 29.8 |

The foregoing pilot test results conducted with a de-supersaturation reactor hydraulic residence time of 10.8 to 14.4 minutes were performed with no continuous external source of gypsum solids, but used only gypsum generated by the de-supersaturation reaction to sustain the process. Moreover, the importance of maintaining an adequate concentration of gypsum solids is demonstrated by the low calcium and sulfate removal efficiency when the solids concentration was about 11 percent by weight or below.

A second test condition was evaluated in the pilot plant, during which the agitated continuous-flow back-mix reactor hydraulic residence time was maintained between 59.7 and 60.6 minutes. The second test condition used concentrate from a reverse osmosis unit that treated sulfate-contaminated groundwater from a mining operation, and was operated for five days. The process also was sustained with gypsum solids that were formed and retained in the de-supersaturation process. Test results are shown in the following table:

| | CALCIUM | | SULFATE | |
|---|---|---|---|---|
| SOLIDS % | INITIAL | % REMOVED | INITIAL | % REMOVED |
| 3.7 | 1,530 | 36.8 | 5,256 | 23.1 |
| 8.3 | 1,559 | 40.3 | 5,293 | 25.3 |
| 15.3 | 1,442 | 39.9 | 5,269 | 29.6 |
| 19.6 | 1,550 | 46.6 | 5,336 | 33.8 |
| 19.8 | 1,534 | 48.1 | 5,244 | 35.1 |

The 5-day test performed with a 60-minute hydraulic residence time in the de-supersaturation reactor demonstrates the successful operation and self-sufficiency of the de-supersaturation process without need for external sources of solids to sustain the process. Moreover, the importance of maintaining an adequate concentration of gypsum solids is demonstrated by the reduced calcium and sulfate removal efficiency when the solids concentration was about 8.3 percent or below.

The examples of continuous-flow operation of the de-supersaturation process in which a single reactor was used can obviously be extended to multiple de-supersaturation reactors that are operated in series, consistent with known principles of chemical engineering. Similarly, solids recovery with a gravity thickener can obviously be extended to other types of liquid-solid separation processes such a hydrocyclone, as previously described.

In embodiments where no scale inhibitor is added to the water, the reactor may be a single-stage, continuous-flow, stirred-tank reactor, and the concentration of the nucleation material in the water in the reactor may be maintained above two percent by weight. If two or three continuous-flow, stirred-tank reactors are used, and the concentration of nucleation material in the water in the stirred-tank reactors may be maintained below two percent by weight. In embodiments where a scale inhibitor is added to the water; and the reactor is a single-stage continuous-flow, stirred-tank reactor, the concentration of the nucleation material in the water may be maintained above 12 percent by weight. If two or three continuous-flow, stirred-tank reactors are used, then the concentration of the nucleation material in the water may be maintained below 12 percent by weight.

Concentrated sulfate-contaminated groundwater from a reverse osmosis plant, and water from other sources that is supersaturated, may be efficiently de-supersaturated and conveyed in pipelines, or may be further concentrated in membrane desalination equipment, or be used in other equipment with little or no potential for scale formation with proper use of scale inhibiting chemicals.

Thus, novel systems and methods have been shown and described. Various substitutions and modifications may of course be made without departing from the spirit and scope of the invention. The invention, therefore, should not be limited, except to the following claims and their equivalents.

1. A method for treating water, comprising:
performing a first separating step by reverse osmosis or electro dialysis, in a first separating system, to separate first intake water into purified clean water and reject water, with the reject water supersaturated with a dissolved solid;
moving the reject water into a reactor;
de-supersaturating the reject water in the reactor in a self-sustaining de-supersaturation process via the reject water contacting a nucleation material in the reactor;
removing a flow of de-supersaturated water from the reactor;
recovering nucleation material and recycling it to the de-supersaturation reactor to maintain the de-supersaturation process; and
performing a second separating step on the de-supersaturated water by reverse osmosis or electro-dialysis, in a second separating system.

2. The method of claim 1 further comprising adding a scale inhibitor to the de-supersaturated water, before performing the second reverse osmosis step in the second reverse osmosis system.

3. The method of claim 1 further comprising moving the de-supersaturated water into a clarifier, and moving a first flow of the de-supersaturated water from the clarifier to the second reverse osmosis system, and moving a second flow of the de-supersaturated water from the clarifier back to the reactor.

4. The method of claim 1 wherein nucleation material is collected from a first location adjacent to a lower end of the reactor and is returned to the reactor at a second location above the first location.

5. The method of claim 1 further comprising moving the de-supersaturated water into a hydrocyclone, and moving a first flow of the de-supersaturated water from the hydrocyclone to the second reverse osmosis system, and moving a second flow of the de-supersaturated water from the hydrocyclone back to the reactor.

6. The method of claim 1 wherein the reject water is supersaturated with gypsum, calcium carbonate, barium sulfate, silica or other scale-forming substances.

7. The method in claim 1 wherein no scale inhibitor is added to the water, the reactor comprises a single-stage, continuous-flow, stirred-tank reactor, and the concentration of the nucleation material in the water in the reactor is maintained above two percent by weight.

8. The method of claim 1 wherein no scale inhibitor is added to the water, the reactor comprises two or three continuous-flow, stirred-tank reactors, and with the concentration of nucleation material in the water in the stirred-tank reactors maintained below two percent by weight.

9. The method of claim 1 further comprising adding a scale inhibitor to the water; the reactor is a single-stage continuous-flow, stirred-tank reactor, and the concentration of the nucleation material in the water in the stirred-tank reactor is maintained above 12 percent by weight.

10. The method of claim 1 further comprising adding a scale inhibitor to the water; the reactor comprises two or three continuous-flow, stirred-tank reactors, and the concentration of the nucleation material in the water in the stirred-tank reactors is maintained below 12 percent by weight.

11. The method of claim 1 wherein the de-supersaturation reactor comprises a packed bed reactor.

12. The method of claim 1 further comprising adding a scale inhibitor to the de-supersaturated water, before performing the second separating step.

13. The method of claim 1 wherein the dissolved solid comprises gypsum, calcium carbonate, barium sulfate, and/or silica.

14. The method of claim 1 wherein reduced scale is formed in a pipe, and the second separating step creates second supersaturated reject water, and further comprising de-supersaturating the second reject water, and then conducting the de-supersaturated reject water through the pipe.

15. A method for treating water, comprising:
performing a first separating step by reverse osmosis or electrodialysis in a first separating system to separate first intake water into purified water and reject water, with the reject water supersaturated with a dissolved solid;
de-supersaturating the reject water by a self-sustaining de-supersaturation process via the reject water contacting a nucleation material;
performing a second operation with the de-supersaturated water to reclaim purified water.

16. A method for treating water containing mine tailings, comprising:
mixing first and second non-supersaturated streams of water in a reactor, with the first stream containing mine tailings and at least a first level of suspended solids, and with the first and second streams forming a supersaturated combination I in the reactor;
substantially continuously de-supersaturating the supersaturated combination in the reactor, with the suspended solids acting as nucleation material, and without recycling precipitated nucleation material to the reactor./

17. A system for treating water, comprising:
a first purification system processing intake water into a purified water stream and a supersaturated reject water stream;
a reactor receiving the supersaturated reject water stream, with the reactor containing a recycled de-supersaturating agent for de-supersaturating the supersaturated reject water in the reactor;
a clarifier receiving the de-supersaturated reject water and separating the de-supersaturated reject water into a first flow and a second flow; and
a second purification system receiving the first flow from the clarifier, and with part of the second flow from the clarifier returned to the reactor.

18. The system of claim 17 wherein the first and second purification systems comprise reverse osmosis systems.

19. A system for treating water, comprising:
a first purification system adapted to process intake water into a purified water stream and a supersaturated reject water stream;
a reactor receiving the supersaturated reject water stream, with the reactor containing a recycled de-supersaturating agent for de-supersaturating the supersaturated reject water in the reactor;
a hydrocyclone receiving the de-supersaturated reject water and separating the de-supersaturated reject water into a first flow and a second flow; and
a second purification system receiving the first flow from the hydrocyclone, and with part of the second flow from the hydrocyclone returned to the reactor.

20. The system of claim 19 with the first and second purification systems comprising reverse osmosis systems.

21. The system of claim 19 with the first and second purification systems comprising electrodialysis or electrodialysis reversal systems.

22. The system of claim 19 with the reactor comprising a stirred tank reactor.

23. The system of claim 19 further comprising a filter positioned to filter the de-supersaturated reject water moving from the clarifier to the second purification system.

24. A system for treating water, comprising:
a first membrane purification system processing intake water into a purified water stream and a supersaturated reject water stream;
a fluidized bed reactor receiving the supersaturated reject water stream, and containing particles reacting with the supersaturated reject water causing a supersaturated dissolved solid in the reject water to precipitate out, leaving the reject water de-supersaturated;
a second membrane purification system receiving the de-supersaturated water from the reactor; or
a down-stream operation such as conveyance through a pipeline that would otherwise be susceptible to scale formation.
